(19) United States
(12) Patent Application Publication
(10) Pub. No.: US 2026/0280930 A1
(43) Pub. Date: Sep. 17, 2026

(54) SUBSCRIBER STATION FOR A SERIAL BUS SYSTEM, AND METHOD FOR COMMUNICATION IN A SERIAL BUS SYSTEM

(71) Applicant: Robert Bosch GmbH, Stuttgart (DE)

(72) Inventors: Arthur Mutter, Neuhausen (DE); Florian Hartwich, Reutlingen (DE)

(21) Appl. No.: 19/544,333

(22) Filed: Feb. 19, 2026

(30) Foreign Application Priority Data
Mar. 12, 2025 (DE) 10 2025 109 349.0

(51) Int. Cl. H04L 12/40

(52) U.S. Cl. CPC H04L 12/40013

(57) ABSTRACT

A subscriber station for a serial bus system and a method for communication in a serial bus system. The subscriber station has a communication control device for controlling serial communication of the subscriber station with another subscriber station and for evaluating at least one signal received from a bus of the bus system based on a frame, in which the bit time in a first communication phase can differ from a bit time in a second communication phase, and an EAFF module for performing a validity check for a frame transmitted to the bus by the subscriber station or received from the bus, wherein the validity check is designed to accept more than one format for frames on the bus as valid if an error signaling with which the subscriber station can signal an error in the frame checked for validity on the bus is switched off.

### CROSS REFERENCE

The present application claims the benefit under 35 U.S.C. § 119 of Germany Patent Application No. DE 10 2025 109 349.0 filed on Mar. 12, 2025, which is expressly incorporated herein by reference in its entirety.

### FIELD

The present disclosure relates to a subscriber station for a serial bus system and to a method for communication in a serial bus system.

### BACKGROUND INFORMATION

Nowadays, a bus system is often used for communication between sensors and control units of technical systems. Such technical systems are, for example, installed in at least one vehicle or are used for the production of items, etc. In the bus system, data are created, transmitted and read as messages. There are many different standards for this purpose, for example CAN CC or CAN FD or CAN XL, which are each standardized in the international standard ISO 11898-1:2024.

The messages are transmitted between the bus subscribers of the bus system, such as sensors, control units, encoders, etc. The bus subscribers are also called nodes or subscriber stations.

In Annex A of the international standard ISO 11898-1:2024, an implementation variant is also described that allows CAN subscriber stations, so-called "CAN FD light responders," to be built, in which some CAN protocol functions are omitted. As a result, such a CAN FD light responder is a smaller and/or function-reduced CAN subscriber station. As a result, such a CAN FD light responder is also a more cost-effective CAN subscriber station than another subscriber station that is usable for CAN CC or CAN FD or CAN XL. In general, a plurality of "CAN FD light responders" can be controlled by a bus subscriber station that is also referred to as a "CAN FD light commander." Each CAN FD-capable subscriber station can be a "CAN FD light commander."

In order to enable data rates of more than 8 Mbit/s, a CAN transceiver type "CAN SIC XL" specified in the standard ISO 11898-2:2024 must be used. Such a transceiver type can be switched between a normal operating mode and a special operating mode that is provided for the data phase of CAN XL frames. In the normal operating mode, the recessive and dominant bus voltage levels from CAN are used. The dominant level can always override the recessive level. However, in the special operating mode of the CAN SIC XL transceiver, symmetrical, equally strong levels are to be generated that cannot override one another. Based on the symmetrical levels, the special operating mode in the data phase of CAN XL frames can enable a higher data rate that can be greater than 8 Mbit/s. Thus, the CAN SIC XL transceiver can switch its operating mode within a CAN XL frame. For this purpose, in the CAN XL frame, the switching bit sequences ADS and DAS are present, in which the operating mode is switched. Without ADS and DAS, the interference signals caused by the switching and the jumps in signal propagation time would make correct reception of a frame impossible. Therefore, the operating mode is not switched within frames of other formats.

However, it is problematic that the conventional error signaling of CAN is carried out by means of error flags, which are typically transmitted dominantly and therefore override recessive bits of the frame. Such an error signaling is not usable in the aforementioned special operating mode for the data phase of CAN XL frames. Therefore, ISO 11898-1:2024 specifies that the CAN error signaling is then to be switched off if the special operating mode for the high bit rates is used. As a result thereof, according to ISO 11898-1:2024 (6.6.21.4 Behaviour when error signaling is disabled), only CAN XL frames may be transmitted and received. Accordingly, the CAN frame formats CAN CC (for Classical CAN) and CAN FD can or may no longer be transmitted when the CAN error signaling is switched off. One reason for this is that CAN CC and CAN FD frames require the CAN error signaling according to ISO 11898-1:2024. Another reason for this is that compatibility with older CAN CC and CAN FD implementations is to be ensured.

It follows therefrom that all three CAN frame formats CAN CC, CAN FD, and CAN XL and their implementation variants are usable only in a common CAN bus system if the symmetrical levels in the data phase, and thus a fast transmission speed with data rates of more than 8 Mbit/s, are dispensed with. The CAN error signaling can then remain switched on.

If a CAN FD light commander and a plurality of CAN FD light responders are to be used in a common CAN bus system with CAN XL subscriber stations, the data rate of the CAN FD light frames must remain limited to the data rate of the arbitration phase of the CAN XL frames. The reason for this is that, according to the implementation variant "CAN FD light" of ISO 11898-1:2024, Annex A, the entire CAN FD frame is transmitted with a constant data rate (not switched). The CAN error signaling in the "CAN FD light responder" is always switched off, regardless of the data rate used. Thus, this is independent of the operating mode of the transceiver, but has the purpose of saving hardware that is needed to control error detection, error counting and the error signaling. In addition, dispensing with large parts of the error detection allows the CAN bit time in pure CAN FD light systems to be shortened, and therefore the bit rate to be increased. This implementation variant uses exclusively CAN FD frames, neither CAN CC nor CAN XL frames. In the "CAN FD light commander," all CAN functions, including the error signaling, remain switched on.

### SUMMARY

It is an object of the present disclosure to provide a subscriber station for a serial bus system and a method for communication in a serial bus system which solve the aforementioned problems. In particular, a subscriber station for a serial bus system and a method for communicating in a serial bus system are to be provided, in which communication in the serial bus system with different frame formats and/or implementation variants is possible not only with high error robustness, but also with the maximum bit rate for the respectively used frame format and thus a high net data transmission rate. In particular, the subscriber station and the method are to be designed for use of all CAN frame formats and different CAN implementation variants on a bus of the bus system.

This object may be achieved by a subscriber station for a serial bus system according to the present disclosure. The subscriber station has a communication control device for controlling serial communication of the subscriber station with another subscriber station of the bus system and for evaluating at least one signal received from a bus of the bus system based on a frame, in which the bit time in a first communication phase can differ from a bit time in a second communication phase, and an EAFF module for performing a validity check for a frame transmitted by the subscriber station to the bus or received from the bus, wherein the validity check is designed to accept more than one format for frames on the bus as valid if an error signaling with which the subscriber station can signal an error in the frame checked for validity on the bus is switched off.

The described subscriber station provides an option, based on which the subscriber station is usable in a bus system in which all three CAN frame formats CAN CC, CAN FD and CAN XL are transmitted via the bus and, optionally, additional communication can be performed according to CAN FD light. As a result, the described subscriber station supports communication with a variety of subscriber stations connectable to a bus system that use different communication standards.

Thus, in a CAN bus system, CAN subscriber stations that exchange CAN XL frames with one another at bit rates up to 20 Mbit/s via SIC XL transceivers, and CAN FD light responder subscriber stations, can be operated together.

The option supported by the described subscriber station can be implemented with low hardware effort.

In the described subscriber station, in particular, CAN implementations are expanded by a configuration option that allows CAN CC and CAN FD frames to be transmitted and received, even though this is not permitted by ISO 11898-1:2024 when SIC XL transceivers are used. The configuration option can be referred to as EAFF for "Enable All Frame Formats."

If the configuration option EAFF is active, functions for error detection and for validity check of transmitted and received frames in the CAN CC and in the CAN FD format are changed over. If the configuration option EAFF is active, the subscriber station can communicate both with other subscriber stations that transmit CAN XL frames, and with CAN FD light responders.

If the configuration option EAFF is not active, the subscriber station is compliant with ISO 11898-1:2024.

The described subscriber station can use, for the CAN XL frames, the special operating mode of the SIC XL transceivers, wherein, for CAN FD or CAN CC frames, the operating mode of the SIC XL transceiver is not switched. The SIC XL transceiver is hereinafter also referred to as a SIC XL transmitting/receiving device.

The described subscriber station thus supports more than one frame format and can transmit data at bit rates greater than 8 Mbit/s to the bus or receive data at bit rates greater than 8 Mbit/s from the bus.

Thus, the subscriber station can be designed to select a frame format from at least two different frame formats, in which the next frame is to be transmitted to the bus. For this purpose, the described subscriber station can, for the and/or in the EAFF mode, disable its function for error signaling for a predetermined frame or for a frame in a predetermined frame format. However, the subscriber station can perform, for each of these two switching versions, namely switching on / switching off, of the error signaling, a reliable validity check for transmitted frames and for received frames. The validity check accepts more than one format for frames on the bus as valid, even if or even when an error signaling with which the subscriber station can signal an error in the frame checked for validity on the bus is switched off.

As a result, the subscriber station can also be used highly advantageously in applications in which data are to be exchanged in a shorter time than previously between the subscriber station and at least one other subscriber station connected via the bus, wherein error robustness is ensured even if other frame formats or implementation variants of the communication occur on the bus.

As a whole, the described subscriber station contributes to making the bus system usable in a more versatile manner at low cost, while nevertheless enabling robust and reliable CAN communication.

Advantageous further embodiments of the subscriber station are disclosed herein.

Possibly, the EAFF module is designed to perform, instead of a first validity check to be performed when the error signaling is switched on, a second validity check when the error signaling is switched off, wherein the second validity check differs from the first validity check that is to be performed, when the error signaling is switched on, for a frame transmitted by the subscriber station to the bus or received from the bus.

The EAFF module can, during the second validity check, be designed to accept a received frame as valid if the EAFF module, during a check of the frame up to after the last bit before an acknowledgment field, has not seen an error, wherein, in the acknowledgment field, other subscriber stations connected to the bus can acknowledge the correct reception of the frame.

Alternatively, the EAFF module can, during the second validity check, be designed to accept a received frame as valid if the EAFF module, during a check of the received frame up to a bit in a field before an acknowledgment field, has not seen an error, wherein, in the acknowledgment field, other subscriber stations connected to the bus can acknowledge the correct reception of the frame.

It is possible that the EAFF module, during the second validity check, is designed to accept a transmitted frame as successfully transmitted if the EAFF module, during a check of the transmitted frame in an acknowledgment field in which other subscriber stations connected to the bus can acknowledge the correct reception of the frame, samples a dominant bit.

It is possible that the EAFF module, during the second validity check, is designed to accept a transmitted frame as successfully transmitted if the EAFF module, during a check of the transmitted frame up to a bit in a field before an acknowledgment field, has not seen an error, wherein, in the acknowledgment field, other subscriber stations connected to the bus can acknowledge the correct reception of the frame.

It is possible that the EAFF module, during the second validity check, is designed to accept a received frame as valid or to accept a transmitted frame as successfully transmitted if the EAFF module, during a check of the frame up to after the last bit before an acknowledgment field, has not seen an error, wherein, in the acknowledgment field, other subscriber stations connected to the bus can acknowledge the correct reception of the frame.

In one example embodiment of the present disclosure, the EAFF module has a configuration block in which a value for at least one validity check configuration bit is stored, which indicates whether or not, when the error signaling is switched off, frames other than CAN XL frames may also be transmitted on the bus. Here, the EAFF module can additionally have an evaluation block for evaluating the value of the at least one configuration bit, a frame validity check block for performing at least the second validity check, and a switching block for switching on or switching off the second validity check of the frame validity check block on the basis of the evaluation of the evaluation block.

Optionally, the subscriber station is a commander subscriber station that is designed to transmit predetermined frames, in a transmission request, via the bus to a responder subscriber station, so that the responder subscriber station transmits a predetermined frame to the commander subscriber station only after the commander subscriber station has requested the responder subscriber station to do so in a predetermined frame. The predetermined frame can be a CAN FD frame in the FBFF format.

It is possible that a bus system has a bus and at least two subscriber stations, which are connected to one another via the bus in such a way that they can communicate serially with one another, and of which one subscriber station is a subscriber station as described above and at least one subscriber station is a responder subscriber station, wherein each of the at least two subscriber stations also has a transmitting/receiving device for transmitting a transmit signal to the bus of the bus system and/or for receiving a signal from the bus of the bus system.

The above-described bus system can also have at least one third subscriber station that is designed for transmitting and/or receiving signals based on a frame, wherein the at least one third subscriber station has a communication control device, which is designed to negotiate with the commander subscriber station in a first communication phase of the frame whether the third subscriber station or the commander subscriber station will receive at least temporarily exclusive, collision-free access to the bus in a subsequent second communication phase.

The aforementioned object may also be achieved by a method for communication in a serial bus system. The method is carried out with a subscriber station that has a communication control device for controlling serial communication of the subscriber station with another subscriber station of the bus system and for evaluating at least one signal received from a bus of the bus system based on a frame, in which the bit time in a first communication phase can differ from a bit time in a second communication phase, wherein the communication control device carries out the steps of performing, with an EAFF module, a validity check for a frame transmitted by the subscriber station to the bus or received from the bus, wherein, in the validity check, more than one format for frames on the bus is accepted as valid if an error signaling with which the subscriber station can signal an error in the frame checked for validity on the bus is switched off.

The method offers the same advantages as those mentioned above in relation to the subscriber station.

Further possible implementations of the present disclosure also include combinations, even those not explicitly mentioned, of features or embodiments described above or below with respect to the exemplary embodiments. In this case, a person skilled in the art will also add individual aspects as improvements or additions to the relevant basic form of the present disclosure.

### BRIEF DESCRIPTION OF THE DRAWINGS

The present disclosure is described in more detail below with reference to the figures and on the basis of exemplary embodiments.

FIG. 1 shows a simplified block diagram of a bus system according to a first exemplary embodiment.

FIG. 2 shows the format of CAN XL frames according to the standard ISO 11898-1:2024 for a message that can be transmitted by a subscriber station of the bus system according to the first exemplary embodiment.

FIG. 3 shows the format of CAN FD frames in the FBFF format without bit rate switching, for a message that can be transmitted as an alternative to the CAN XL frame of FIG. 2 by a subscriber station of the bus system according to the first exemplary embodiment.

FIG. 4 shows a simplified schematic block circuit diagram of a first subscriber station of the bus system according to the first exemplary embodiment, which is designed for CAN XL and, in the implementation variant CAN FD light, can execute a commander function.

FIG. 5 shows a time profile of a first digital transmit signal in operation of the bus system at the first subscriber station, which is connected to the same bus of the bus system along with at least one second subscriber station, and if communication on the bus is performed according to the standard of CAN XL.

FIG. 6 shows a time profile of bus signals CAN_H and CAN_L at the first subscriber station if the first subscriber station uses the standard of CAN XL for transmitting the transmit signal of FIG. 5 to the bus.

FIG. 7 shows a time profile of a differential voltage VDIFF of the bus signals CAN_H and CAN_L on the bus as a result of the signals of FIG. 6.

FIG. 8 shows a time profile of a digital receive signal that the first or a second subscriber station generates from a signal received from the bus, which signal is based on the transmit signal of FIG. 5.

FIG. 9 shows a time profile of a second digital transmit signal in operation of the bus system at the first subscriber station if communication on the bus is performed according to the standard of CAN CC or CAN FD or CAN FD light.

FIG. 10 shows a time profile of bus signals CAN_H and CAN_L at the first subscriber station, which are transmitted to the bus based on the transmit signal of FIG. 9.

FIG. 11 shows a time profile of a differential voltage VDIFF of the bus signals CAN_H and CAN_L of FIG. 10 at the first subscriber station.

FIG. 12 shows a time profile of a digital receive signal that the first or a second subscriber station generates from a signal received from the bus, which signal is based on the transmit signal of FIG. 9.

FIG. 13 shows a simplified schematic block diagram of a second subscriber station (responder) of the bus system according to the first exemplary embodiment.

In the figures, identical or functionally identical elements are given the same reference signs unless otherwise indicated.

### DETAILED DESCRIPTION OF THE EXAMPLE EMBODIMENTS

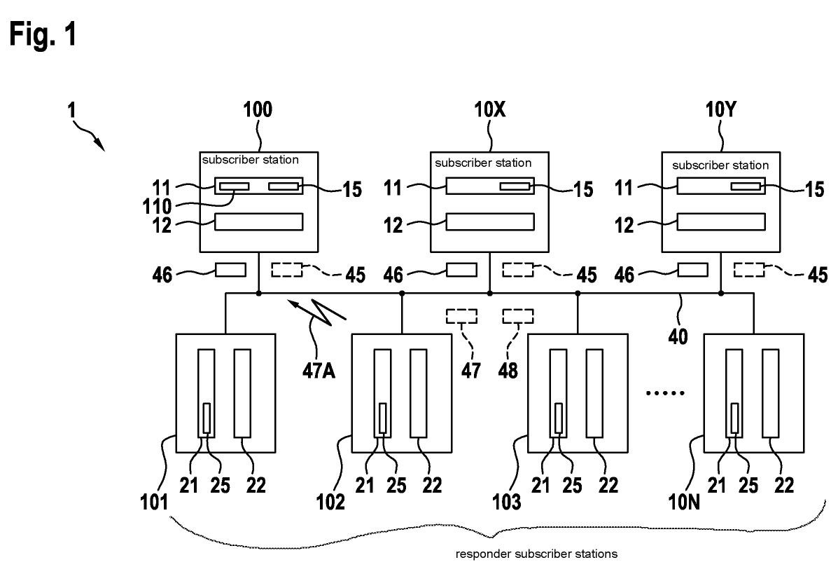

FIG. 1 shows, as an example, a bus system 1, which is in particular fundamentally designed for a CAN FD bus system, a CAN XL bus system, a CAN FD light bus system, and/or any combinations thereof and/or modifications thereof, as described below. The bus system 1 can be used in a vehicle, in particular a motor vehicle, an aircraft, etc., or in a hospital, etc.

In FIG. 1, the bus system 1 has a bus 40 to which a subscriber station 10X, a subscriber station 10Y, a subscriber station 100, and a plurality of responder subscriber stations 101, 102, 103 ... 10N are each connected. N is a natural number greater than or equal to 1. 1 to N responder subscriber stations 101, 102, 103 … 10N can be connected to the bus 40.

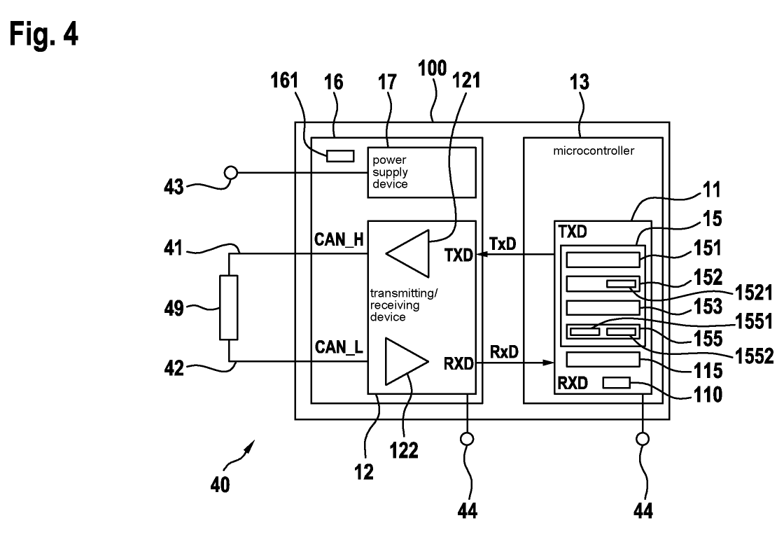

The bus 40 can have a first bus wire 41 (FIG. 4) and a second bus wire 42 (FIG. 4), which are not shown in FIG. 1. The bus wires can also be referred to as CAN_H and CAN_L and are used for electrical signal transmission after the coupling-in of the dominant levels or generation of recessive levels or other levels for a signal in the transmission state.

The subscriber stations 100, 10X, 10Y are, for example, CAN XL subscriber stations. Possibly, in addition to the subscriber station 100, only one of the subscriber stations 10X, 10Y is connected to the bus 40.

For example, the subscriber station 100 can perform the function of a commander subscriber station. Therefore, at least the subscriber station 100 is designed to perform communication according to CAN FD light, which is hereinafter also referred to as FDL. For this purpose, the subscriber station 100 has an FDL module 110, which implements the functions specified in Annex A of the international standard ISO 11898-1:2024 for a commander in communication according to CAN FD light. For this purpose, the subscriber station 100 has an FDL module 110. The subscriber station 100 is hereinafter also referred to as commander subscriber station 100 if it carries out the function of a commander in communication according to CAN FD light. Possibly, the subscriber stations 10X, 10Y also each have an FDL module 110, even if this is not shown in FIG. 1.

The subscriber station 100 is, for example, a control unit of a motor vehicle or of another technical installation, as described in more detail below. The responder subscriber stations 101, 102, 103 ... 10N can, for example, have at least one sensor, at least one display device, at least one actuator, at least one transducer, etc. of a motor vehicle or other technical system, as described in more detail below.

As shown in FIG. 1, each of the subscriber stations 100, 10X, 10Y has a communication control device 11, a transmitting/receiving device 12 and an EAFF switching module 15. "EAFF" stands for "Enable All Frame Formats," which is equivalent to enabling or permitting all frame formats. In general, an EAFF switching module 15 is mandatory only for the subscriber station of subscriber stations 100, 10X, 10Y that is to be used as commander for at least one of the responder subscriber stations 101, 102, 103 … 10N.

Each of the responder subscriber stations 101, 102, 103 … 10N has a communication control device 21, a transmitting/receiving device 22 and an FDL module 25. Each of the responder subscriber stations 101, 102, 103 … 10N is also designed to perform communication according to CAN FD light.

The transmitting/receiving devices 12, 22 of the subscriber stations 100 … 10N are each directly connected to the bus 40, even if this is not shown in FIG. 1. The transmitting/receiving device 12 is designed as a SIC XL transmitting/receiving device.

Each of the subscriber stations 100, 10X, 10Y is designed to generate messages 45, 46 in the form of signals. Each of the subscriber stations 100, 10X, 10Y transmits the respective message 45, 46 serially to the bus 40. The message 45 can be constructed according to CAN XL, which is compatible with CAN FD and is specified in ISO 11898-1:2024. With CAN XL, communication on the bus 40 is possible at bit rates of up to 20 Mbit/s and with a data volume of up to 2048 bytes per message. The message 46 can be constructed according to CAN FD.

In addition, each of the subscriber stations 100, 10X, 10Y is designed, according to ISO 11898-1:2024, to transmit, in the corresponding operating case, an error frame 47 or an overload frame 48 to the bus 40. If one of the subscriber stations 100, 10X, 10Y detects an error 47A in communication on the bus 40 and the function of the error signaling is switched on, it transmits an error frame 47 to the bus 40.

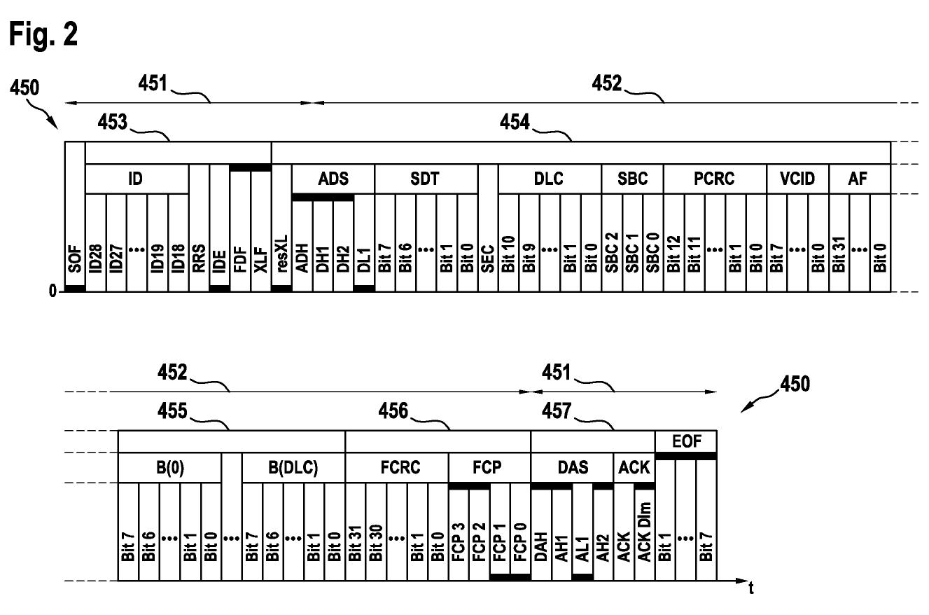

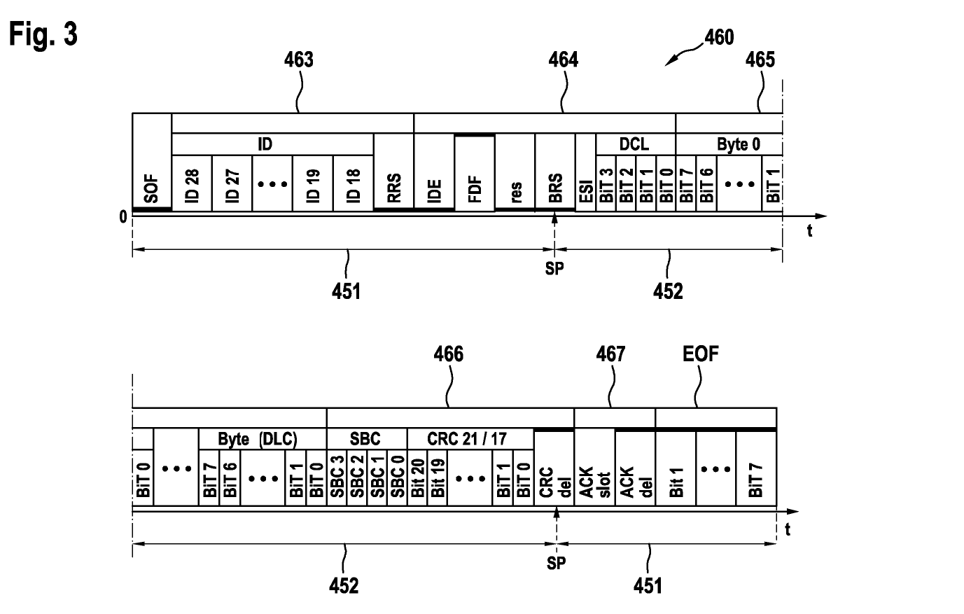

In its function as commander according to CAN FD light, the subscriber station 100 is designed to transmit messages 46, in the form of signals, to one of the responder subscriber stations 101 … 10N via the bus 40. The message 46 is constructed according to the FBFF format of CAN FD. Thus, the message 46 is constructed, at least in part, in the same way as a message 45. This is described in more detail below with reference to FIGS. 2 and 3. However, the subscriber station 100 is designed to communicate via the bus 40, without reconfiguration, with at least one of the other subscriber stations 10X, 10Y by means of message(s) 45. For this purpose, the EAFF module 15 is used, as described in more detail below based on FIGS. 4 to 8.

The subscriber stations 101 ... 10N in FIG. 1 are designed to create messages 46 in the form of signals and to transmit them to the commander subscriber station, for example the subscriber station 100 via the bus 40. The messages 46 can be transmitted serially between the commander subscriber station and one of the subscriber stations 101 to 10N.

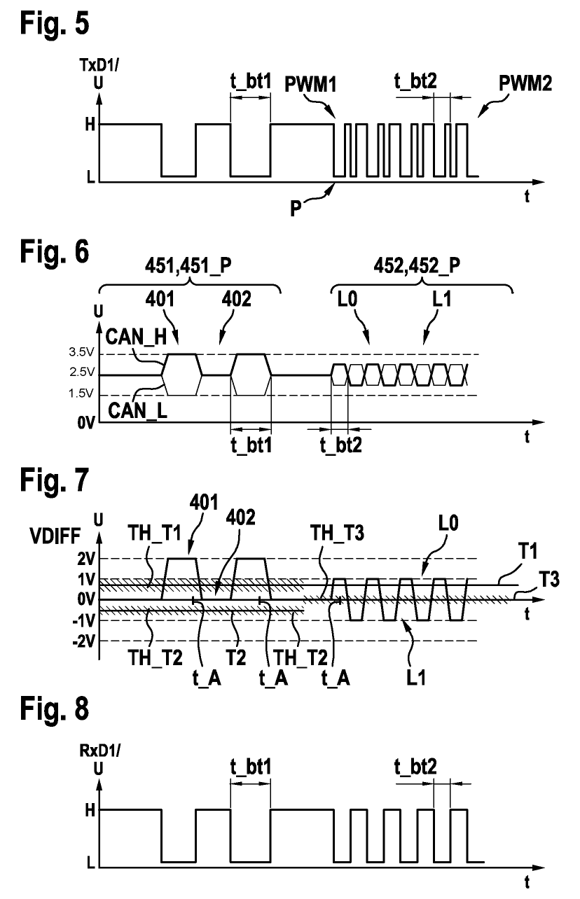

The communication control devices 11, 21 are each designed for controlling communication via the bus 40 with one of the other subscriber stations 100, 10X, 10Y, 101 … 10N connected to the bus 40. The communication control devices 11 generate, where required, one of the transmit signals TxD1, TxD2, which are described in more detail below with reference to FIGS. 5 to 9. In addition, the communication control devices 11 read or decode one of the receive signals RxD1, RxD2, which are described in more detail below with reference to FIGS. 8 to 12.

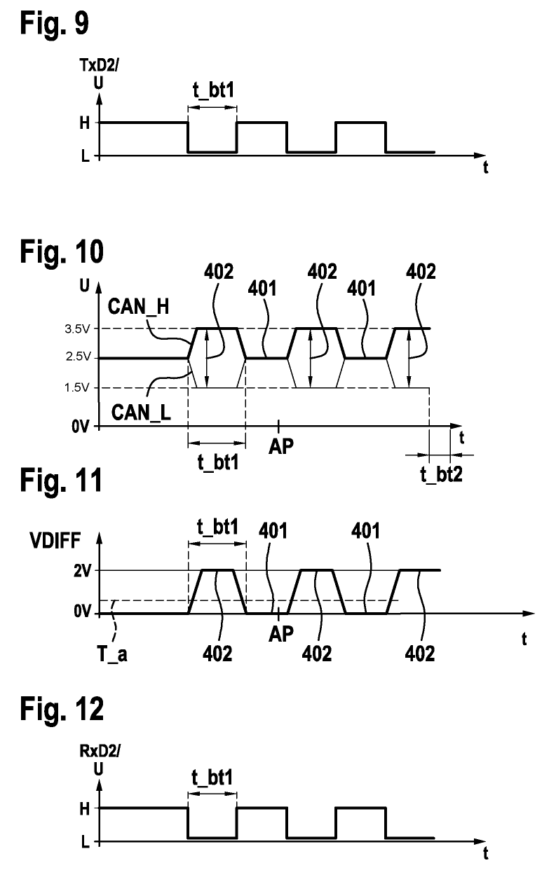

The communication control devices 21 generate, where required, a transmit signal TxD2 according to FIG. 9. In addition, the communication control devices 21 read or decode a receive signal RxD2 according to FIG. 12.

The communication control device 11 can be implemented, at least in part, like a conventional CAN controller according to ISO 11898-1:2024, i.e., like a CAN XL controller that can also communicate via the bus 40 according to CAN FD or CAN FD light and has functions of a CAN FD tolerant Classical CAN controller. In the case of the CAN FD messages 45, a number of 0 to 64 data bytes can be included, which are in addition transmitted at a significantly faster data rate than in the case of a Classical CAN message. Optionally, each of the subscriber stations 100, 10X, 10Y can also be designed for communication according to Classical CAN and thus transmit CAN CC frames that are also specified in ISO 11898-1:2024.

The communication control device 11 is implemented to provide or receive, as needed, a CAN XL message 45 or a CAN FD message 46 for one of the subscriber stations 100, 10X, 10Y, or to communicate with one of the subscriber stations 101 ... 101N via the bus 40. Here, the EAFF modules 15 are also used.

The communication control device 11 thus creates and reads a first message 45 or a second message 46, wherein the first and second messages 45, 46 differ in their data transmission standard, namely in this case CAN XL and CAN FD. In addition, the communication control device 11 can perform the function of a commander controller for CAN FD light or can generate and read messages according to Classical CAN, which is also referred to as CAN CC.

The communication control device 21 can perform the function of a responder controller for CAN FD light. For this purpose, the FDL module 25 is present, which has functions that are compatible with the functions of the FDL module 110 of the subscriber station 100. The communication control device 21 creates second messages 46 and is designed to read messages 46.

In general, if the subscriber station 100, 10X, 10Y is at least in part a conventional CAN XL subscriber station, the subscriber station 100, 10X, 10Y also supports CAN FD and CAN CC. The subscriber stations 100 ... 10N, on the other hand, are designed for CAN FD light and support exclusively frame 460 (CAN FD format) according to FIG. 3 when transmitting and receiving.

For communication with one of the subscriber stations 101 … 100N, for example, the subscriber station 100, in its function as commander, transmits a transmission request via the bus 40 to the desired subscriber station 101 … 100N. The transmission request is carried out by transmitting a message 46 that is based on a frame shown in FIG. 3. A responder subscriber station 101 … 100N transmits a message 46, which is based on a frame shown in FIG. 3, via the bus 40 to the subscriber station 100 only after the subscriber station 100 has requested the subscriber station 101 … 100N to do so by means of a transmission request. The subscriber station 100 can, in this function, also be designated as commander subscriber station 100.

Thus, the subscriber station 100 has the function of a command issuer/poller, and the subscriber station 101 … 101N has the function of a responder. Therefore, the subscriber station 100 is hereinafter also designated, in this function, as the FDL commander, and the subscriber station 101 ... 101N is designated as the FDL responder.

FIG. 2 shows a frame 450 that can be generated by the subscriber station 100 or by one of the subscriber stations 10X, 10Y for a message 45 in the CAN XL frame format specified in ISO 11898-1:2024. However, the subscriber stations 100, 10X, 10Y are not limited to the frame 450 of FIG. 2, but can use another frame for communication on the bus 40.

The CAN XL frame 450 according to FIG. 2 can be provided by one of the subscriber stations 100, 10X, 10Y, or by the communication control device 11, namely encoded in a digital transmit signal TxD or TxD1, to the associated transmitting/receiving device 12 in order to transmit the frame 450 onto the bus 40 to another subscriber station of the subscriber stations 100, 10X, 10Y.

The frame 450 is divided into two communication phases, which are referred to as an arbitration phase 451 (first communication phase) and a data phase 452 (second communication phase), as is customary for the CAN communication types CAN CC, CAN FD, CAN FD light and CAN XL. The frame 450 begins and ends in the arbitration phase 451, in which arbitration takes place on the bus 40, in which it is negotiated which subscriber station has exclusive access to the bus 40 in the subsequent data phase, as described in more detail below.

In CAN XL, the subscriber stations 100, 10X, 10Y use, in the first communication phase (arbitration phase) 451, recessive and dominant levels as in CAN FD. However, in the second communication phase (data phase) 452, the subscriber stations 100, 10X, 10Y can either use the recessive and dominant levels or instead symmetrical '1' and '0' levels (special operating mode) for transmission of the frame 450 on the bus 40 of FIG. 1, as described above. Thus, CAN XL frames 450 can be transmitted without switching the operating mode of the transmitting/receiving device 12. If the transmitting/receiving device 12 is a SIC XL transceiver, then up to 8 Mbit/s are possible in the data phase 452. However, the subscriber stations 101 ... 101N (FDL responders), which are designed only for communication with CAN FD frames 46, cannot decode such frames 450.

A communication control device 11 designed for CAN XL has its own configuration bit, which is referred to as the TMS bit. Using the TMS bit, the communication control device 11 can be configured such that switching of the operating mode within a CAN XL frame 450 is enabled, i.e., performed (transceiver mode switching enabled). If the TMS bit is set, i.e., the switching of the operating mode is enabled, the communication control device 11 is designed, in the data phase 452 of CAN XL frames 450, to signal to the transmitting/receiving device 12, via PWM encoding at the TXD terminal (FIG. 4), that the device 12 is to generate symmetrical '1' and '0' levels (special operating mode) and is therefore to be switched into the FAST_TX operating mode or the FAST_RX operating mode. This is described in more detail below.

In the data phase 452 of CAN FD frames 460 (FIG. 3), the PWM encoding is not used.

If the TMS bit is set, i.e., the switching of the operating mode is enabled, the error signaling is also to be switched off for the communication control device 11. For this purpose, a separate configuration bit is present. If the error signaling is switched off, all other frame formats except the format for frames 450 (CAN XL) are also disabled. The communication control device 11 can then communicate only with frames 450 via the bus 40.

The EAFF bit is intended to enable these other frame formats again.

The FDL module 110 is designed, for communication with CAN FD light, to disable the special operating mode of the transmitting/receiving device 12 designed as a SIC XL transceiver. As a result, no transmission of symmetrical '1' and '0' levels in the second communication phase (data phase) 452 is possible. As a result, use of the subscriber station 100 (CAN XL subscriber station) as a CAN FD light commander is possible.

The frame 450 of FIG. 2 begins with an SOF bit and has an arbitration field 453, a control field 454 with an ADS field for switching between the communication phases 451, 452, a data field 455, a checksum field 456 (CRC field), a frame termination field 457 and an end-of-frame field EOF (EOF = end of frame). The CAN XL format is specified in ISO 11898-1:2024.

Even if this is not shown in FIG. 2, bits in the first communication phase (arbitration phase) 451 of the frame 450 can have a longer bit time than bits of the second communication phase (data phase) 452. The switching from the bits with the bit time of the first communication phase (arbitration phase) 451 to the bits with the bit time of the second communication phase (data phase) 452 is carried out at the beginning of the control field 454 in an ADH bit.

In CAN XL, bits that are shown with a thick line on their lower edge in FIG. 2 are transmitted in the frame 450 as dominant or 'L0', in particular L = low or '0'. Bits that are shown with a thick line on their upper edge in FIG. 2 are transmitted in the frame 450 as recessive or 'L1', in particular H = high or '1'. Such bits, which are shown in FIG. 2 with a thick line, have a predetermined permanent or fixed value in the frame 450.

The arbitration field 453 of the arbitration phase 451 is provided in CAN XL in order to perform arbitration for the frame 450 of FIG. 2 with the aid of the identifier (ID). In the first communication phase (arbitration phase) 451, a bit rate of less than 1 Mbit/s can be used in the present exemplary embodiment.

According to FIG. 2, in the data phase 452, in addition to a portion of the control field 454 of the frame 450, the payload data of the CAN XL frame 450 or of the message 45 are transmitted from the data field 455 and the checksum field 456. In the data phase 452, in the present exemplary embodiment, a data bit rate is used which can have values of in particular up to 20 Mbit/s. As a result, a significantly faster transmission speed is possible in the phase 452 than in the first communication phase 451.

According to FIG. 2, the frame 450 contains an ADS field and a DAS field. These two fields serve in CAN XL for switching the bit rate and for switching the transmitting/receiving device 12 (transceiver) from the SIC operating mode used for the arbitration phase 451 into the FAST_TX or FAST_RX operating modes used for the data phase 452, or from the FAST operating modes back into the SIC operating mode. The FAST_TX operating mode is used if the subscriber station 100, 10X, 10Y is the transmitter of the frame 450 on the bus 40 in the data phase 452 of the frame 450. The FAST_RX operating mode is used if the subscriber station in the data phase 452 of the frame 450 is not the transmitter, but only the receiver of the frame 450 from the bus 40.

In the CAN XL frame of FIG. 2, the res bit from CAN FD, which is designated as the XLF bit in the frame 450, has the function of switching from the CAN FD format to the CAN XL format. The frame formats of CAN FD and CAN XL are identical up to the res bit or XLF bit. The XLF bit is transmitted as 1, i.e., recessive, in CAN XL in order to identify the frame 450 as a CAN XL frame. For a CAN FD frame, the communication control device 11 sets the bit as 0 or L (low), i.e., as a dominant res bit.

As shown in FIG. 2, in the frame 450, the XLF bit is followed by a resXL bit, which is a dominant bit reserved for future use. The resXL bit must be transmitted as 0, i.e., dominant, for the frame 450 in CAN XL.

Following the resXL bit, the frame 450 includes an ADS (arbitration data switch) sequence in an ADS field, which was described above in connection with the DAS field.

The following fields up to the beginning of the data field 455 are not described in more detail here. The data field 455 can have up to 2048 bytes according to ISO 11898-1:2024. The length of the data field 455 is encoded in bits 0 to 10 of the DLC field.

Following the data field 455, the frame 450 includes the checksum field 456 with a frame checksum FCRC and an FCP field. Here, FCP = frame check pattern. The FCP field consists of 4 bits with in particular the bit sequence 1100. A receiver (receiving node) of the frame 450 checks, by means of the FCP field, whether the receiver (receiving node) is bit-synchronous with the transmission data stream. In addition, a receiving node synchronizes to the falling edge in the FCP field.

The FCP field is followed by the frame termination field 457. The frame termination field 457 consists of two fields, namely the DAS field, as described above and below, and the acknowledgment field or ACK field (ACK = acknowledge) with the at least one ACK bit and the ACK-Dlm bit.

The DAS field has already been described above.

As mentioned, in CAN XL, within a frame 450, the physical layer is switched from recessive and dominant bus states to a physical layer for the bus states L0, L1 in order to transmit a message 45 between the subscriber stations 100, 10X, 10Y. The switching between the operating modes of the transmitting/receiving device 12, 22 is carried out in CAN XL in the ADS and DAS fields. The communication control devices 11, 21 optionally signal, if the transceiver mode switching is enabled, to their associated transmitting/receiving device 12, 22, by means of pulse-width modulation via the transmit signal TxD1 of FIG. 5, that switching is to be performed, as already mentioned above.

The AH1 bit is followed by the AL1 bit (logical 0) and the AH2 bit (logical 1). The two bits DAH and AH1 ensure that all subscriber stations 100, 101, up to 10N see a recessive level of significantly more than one arbitration bit time before the edge at the beginning of the AL1 bit (logical 0). This ensures reliable synchronization for the subscriber stations of the bus system 1.

In the frame termination field 457, the sequence of the DAS field is followed by the acknowledgment field or ACK field. The acknowledgment field or ACK field contains placeholders or bits ACK, ACK Dlm for acknowledging or not acknowledging correct reception of the frame 450. In CAN XL, a receiving subscriber station 100, 10X, 10Y transmits a transmission acknowledgment (ACK bit) with the dominant bus state, which stands for successful reception. In contrast, a transmitting subscriber station always transmits the ACK bit as a recessive bus state. In CAN FD light, the acknowledge function can be switched off. This applies in particular to the FDL mode for higher bit rates.

In the frame 450, the frame termination field 457 is followed by the end-of-frame field (EOF = end of frame), as in the case of CAN FD according to ISO 11898-1:2024.

After the end-of-frame field (EOF), an interframe space (IFS – interframe space) (not shown in FIG. 2) follows in the frame 450. In CAN FD, this interframe space (IFS) is designed in accordance with ISO 11898-1:2024. The interframe space (IFS) has at least 3 bits.

The following applies to CAN XL.

In contrast to CAN FD, the identifier ID of the frame 450 is called "Priority ID" in the case of CAN XL.

In contrast to CAN FD, CAN XL can transmit the RRS bit as (logical) 0 or as (logical) 1. In CAN FD, the RRS bit is always transmitted as logical 0.

FIG. 3 shows a frame 460 for a message 46 with up to 64 data bytes in the CAN FD FBFF format according to ISO 11898-1:2024. The CAN FD frame 460 can be provided by the communication control device 11, namely encoded in a digital transmit signal TxD2 of FIG. 9, for the associated transmitting/receiving device 12 for transmitting to the bus 40, to another of the subscriber stations 100, 10X, 10Y. For example, the subscriber station 100 can alternatively transmit the CAN FD frame 460 of FIG. 3 to one of the responder subscriber stations 100 … 10N. Alternatively, the frame 460 can be provided as a CAN FD light frame by a subscriber station (responder) 101 … 10N, or by its communication control device 21, namely encoded in a digital transmit signal TxD2 according to FIG. 9, for the associated transmitting/receiving device 22 for transmitting to the bus 40. Here, the communication control device 21 creates the frame 460 in the present exemplary embodiment as compatible with CAN FD, as also illustrated in FIG. 3.

The frame 460 is divided into two communication phases, the arbitration phase 451 (first communication phase) and the data phase 452 (second communication phase), as mentioned above. The frame 460 begins and ends in the arbitration phase 451. The frame 460 begins with a start bit (SOF bit) and has an arbitration field 463, a control field 464, a data field 465, a checksum field 466 (CRC field), an acknowledgment field 467 (ACK = acknowledge) and an end-of-frame field EOF.

Bits in the arbitration phase 451 of the frame 460 possibly have a longer bit time than bits of the data phase 452, as illustrated in FIG. 3 by way of example. The switching from the bits with the bit time of the arbitration phase 451 to the bits with the bit time of the data phase 452 is carried out in a BRS bit, as marked SP in FIG. 3. In the FBFF format of ISO 11898-1:2024, the transmitter of the frame 460 can decide whether it sets the BRS bit to 1 or to 0, wherein BRS = Bit Rate Switch. If the BRS bit is set to 1, the bit rate is increased, or the bit time is shortened, in the data phase 452. If the BRS bit is set to 0, the bit rate or bit time is the same in the two communication phases 451, 452. In CAN FD light, it is currently provided that the bit rate is not switched within the frame 460. Therefore, BRS = 0 is transmitted. Accordingly, the FDL module 110 of the commander, for example the subscriber station 100, is designed to set the BRS bit to 0 in a message 46 to the responder (one of the subscriber stations 101 … 10N), so that the responder understands it. A special aspect is that, in CAN FD light, because of the absence of arbitration, bit rates > 1 Mbit/s are also permitted, in particular up to 8 Mbit/s. This is a significant difference relative to communication according to CAN FD in the bus system 1, in which, in the arbitration phase, for example because of arbitration, the bit rate must be ≤ 1 Mbit/s. Another reason for such a limitation of the bit rate is also the ACK bit transmitted by the receiver of the frame 460, which otherwise would be seen by the transmitter of the frame 460 at a bit rate of 8 Mbit/s only during the end-of-frame field EOF.

The function of the BRS bit for communication between the subscriber station 100 as commander and the responder subscriber stations 100 … 10N is described in more detail below.

Bits shown with a thick line on their lower line in FIG. 3 are transmitted in the frame 460 as dominant or '0.' Bits shown with a thick line on their upper line in FIG. 3 are transmitted in the frame 460 as recessive or '1.' Such bits, which are shown in FIG. 3 with a thick line, have a predetermined permanent or fixed value in the frame 460.

The arbitration field 463 comprises an identifier of the frame 460 in the ID field. The identifier has 11 bits. An RRS bit is arranged at the end of the arbitration field 463.

The control field 464 begins with an IDE bit, followed by an FDF bit and a res bit. These are followed by the BRS bit and an ESI bit. Thus, the ESI bit is the first bit in the frame 460 with the bit time of the data phase 452.

The control field 464 ends with a DLC field in which the length of the following data field 465 is encoded. The res bit must be transmitted for the frame 460 with a logical value 0, in other words as (logical) 0, i.e., dominant.

The data field 465 will not be present if the DLC field of the control field 463 has the value 0. The data field 465 has a length corresponding to the value encoded in the DLC field. The value can be up to 64 bytes, as mentioned above.

The checksum field 466 contains in a field SBC the number of stuff bits modulo 8 which have been inserted into the frame 460 according to the bit stuffing rule, namely that following five identical bits, a bit inverse thereto is to be inserted in each case, as specified in ISO 11898-1:2024. In addition, the checksum field 466 in a CRC field contains a CRC checksum and, following this, ends with a CRC delimiter CRC-Del.

The switching from the bits with the bit time of the data phase 452 to the bits with the bit time of the arbitration phase 451 is carried out in the bit CRC-Del, as marked with SP in FIG. 3.

The acknowledgment field 467 contains an ACK slot bit in which subscriber stations, which currently are only receivers of the frame 460 but not transmitters of the frame, can acknowledge or not acknowledge the correct reception of the frame 460 from the bus 40. The acknowledgment field 467 ends with an ACK-Del bit, which is also called ACK delimiter.

A bit sequence is provided in the end-of-frame field EOF, which bit sequence marks the end of the frame 460. This means that the bit sequence of the end field (EOF) is used to mark the end of the frame 460. The end field (EOF), together with the ACK delimiter, ensures that a number of 8 recessive bits is transmitted at the end of the frame 460. This is a bit sequence that cannot occur within the frame 460. As a result, the end of the frame 460 can be reliably recognized by the subscriber stations 100, 101 … 10N, 10X, 10Y.

After the end field (EOF), which has 7 bits, an interframe space (IFS), not shown in FIG. 3, follows in the frame 460. In CAN FD this interframe space (IFS) is designed in accordance with ISO 11898-1:2024. The interframe space (IFS) has at least 3 bits.

Otherwise, the fields and bits mentioned are from ISO 11898-1:2024 and for this reason are not described in more detail here.

In the arbitration phase 451 of CAN FD or CAN XL, with the aid of the identifier (ID) with, for example, bits ID28 to ID18 in the arbitration field 453, negotiation takes place bit by bit between the subscriber stations 100, 10X, 10Y or other CAN FD or CAN XL subscriber stations on the bus 40 as to which subscriber station 100, 10X, 10Y wants to transmit the message 45 with the highest priority and will therefore receive exclusive access to the bus 40 of the bus system 1 for the near future for transmitting in the subsequent data phase 452. A physical layer such as in CAN and CAN FD is used in the arbitration phase 451. The physical layer corresponds to the bit transmission layer or layer 1 of the conventional OSI model (Open Systems Interconnection Model).

The subscriber stations 101 ... 10N, as FDL Light responder subscriber stations, do not support arbitration, as mentioned above and as described in more detail below.

In order to manage without CAN arbitration, in which the conventional CSMA/CR method resolves a collision if two CAN nodes (subscriber stations) start a message at the same time, the commander must specify when which responder is allowed to transmit a message. This means that if the commander has requested, via a transmission request, a specific responder to transmit, the commander will wait until the responder has responded before the commander transmits any other message. If a responder that has received a transmission request but has not yet started its response sees the start of another message on the CAN bus 40, it considers its transmission request as completed and does not start its message 46. Annex A to ISO 11898-1:2024 specifies the earliest possible point in time at which a responder may answer the transmission request with a message 46. This transmission start can be delayed if the responder needs more time to prepare the transmission data. The response times of the various responders in the CAN system are known to the commander.

Collisions between FDL responders (subscriber stations 101 … 10N) and the commander (subscriber station 100) or other CAN FD nodes (e.g., subscriber stations 10X, 10Y) that may be present, which contain the arbitration function, can also be avoided by assigning identifiers having higher arbitration priority to the responders for transmission.. As a result, if the other nodes start a message at the same time as a responder, they will lose the arbitration and become the receiver.

The subscriber station 100 as the transmitter of a message 45, 46 does not begin transmitting bits of the data phase 452 to the bus 40 until the subscriber station 100 as the transmitter has won the arbitration and the subscriber station 100 as transmitter thus has exclusive access to the bus 40 of the bus system 1 for transmission. The same applies to each CAN FD or CAN XL subscriber station 10X, 10Y that is connected to the bus 40 and wants to transmit a message 45, 46 to the bus 40.

In the arbitration phase 451, in a CAN FD light communication with a frame 460, the responder thus does not carry out arbitration, which was described above with reference to FIGS. 2 and 3. Instead, the communication control device 21, as FDL responder, is designed to write into the frame 460 the identifier (ID) that was assigned to the responder. If, for example, the subscriber station 101 (responder) receives a transmission request from the subscriber station 100 (commander), the subscriber station 101 transmits an FDL frame 460 according to FIG. 3, or a message 46, via the bus 40 to the subscriber station 100. In CAN communication and in FDL, the identifiers (ID) are sender addresses or content indications, but are not receiver addresses. Each identifier may be transmitted only by a predetermined subscriber station 100 to 10N, so that the commander recognizes the particular sender. If a subscriber station 100 to 10N can transmit different data packets, this subscriber station, and only it, may use different identifiers (ID) for transmitting these data. However, for the sake of simplicity, the commander could poll the responders with different identifiers (ID). Alternatively, the commander could poll the responders with a frame 460 having a general polling identifier (ID) and then encode, in the data field 465 in this frame 460, which responder is intended. The intended responder then responds, wherein each of them uses its own identifier (ID) in doing so.

When switching into the data phase 452, in CAN FD light communication no bit rate switching takes place in the frame 460. That is, the bit time of bits of the arbitration phase 451 and of the data phase 452 is the same. However, it is possible that the bit time in the first communication phase (arbitration phase) 451 can differ from the bit time in the second communication phase (data phase) 452 if the communication is not carried out in CAN FD light applications.

In the data phase 452, in addition to a portion of the control field 464 of the frame 460, the payload data of the frame 460 or of the message 46 are transmitted from the data field 465 as well as the checksum field 466. At the end of the checksum field 466, or before the acknowledgment field 467, there is a transition from the data phase 452 back into the arbitration phase 451 according to FIG. 3.

FIG. 4 shows the basic structure of the subscriber station 100 with the communication control device 11, the transmitting/receiving device 12, and the EAFF module 15, which is part of the communication control device 11. The communication control device 11 additionally has an error signaling module 115. The subscriber stations 10X, 10Y are optionally constructed in the same way as the subscriber station 100, as described above. Therefore, the structure of the subscriber stations 10X, 10Y is not described separately.

According to FIG. 4, the subscriber station 100 has, in addition to the communication control device 11 and the transmitting/receiving device 12, a microcontroller 13 to which the communication control device 11 is assigned, and a system ASIC 16 (ASIC = application-specific integrated circuit), which can alternatively be a system basis chip (SBC) on which a plurality of functions necessary for an electronics module of the subscriber station 100 are combined. The system ASIC 16 in particular has an application 161, which can be designed as a computer program (app) or software. Such an application is a technical application 161. The application 161 is, for example, any application in a vehicle. In particular, the application is a windshield washer system and/or a driver assistance system, etc. For example, the windshield washer system controls the movement of at least one windshield wiper (actuator) using data from a rain sensor and/or wind sensor and/or speed sensor and/or light sensor, and/or a warning light (actuator) can be switched on or off. However, the application is not limited to a windshield washer system or parts thereof.

In the system ASIC 16, a power supply device 17 which supplies the transmitting/receiving device 12 with electrical energy is installed in addition to the transmitting/receiving device 12. The power supply device 17 usually supplies a voltage CAN_Supply of 5 V. Depending on requirements, however, the power supply device 17 can provide a different voltage with a different value. Additionally or alternatively, the power supply device 17 can be designed as a current source.

If the communication control device 11 acts as a CAN FD light commander, the communication control device 11 possibly generates a frame 460 in which no bit rate switching/bit rate change is carried out, and/or evaluates such a frame 460.

The EAFF module 15 has an evaluation block 151, a configuration block 152, a switching block 153 and an EAFF frame validity check block 155. In particular, a value for at least one EAFF configuration bit 1521 can be stored in the configuration block 152. The EAFF module 15 has the functions already described above and is described in more detail below.

The EAFF module 15, in particular the evaluation block 151, the switching block 153 and the EAFF frame validity check block 155, can be implemented at least partly as software. The error signaling module 115 can perform an error signaling, as specified in ISO 11898-1:2024.

The transmitting/receiving device 12 also has a transmitting module 121 and a receiving module 122. Although reference is always made to the transmitting/receiving device 12 below, it is alternatively possible to provide the receiving module 122 in a separate device externally from the transmitting module 121. The transmitting module 121 and the receiving module 122 can be constructed as in a conventional transmitting/receiving device 22. The transmitting module 121 can in particular have at least one operational amplifier and/or a transistor. The receiving module 122 can in particular have at least one operational amplifier and/or a transistor.

The transmitting/receiving device 12 is connected to the bus 40, more specifically its first bus wire 41 for CAN_H and its second bus wire 42 for CAN_L. The voltage supply for the power supply device 17 for supplying the first and second bus wires 41, 42 with electrical energy, in particular with the voltage CAN-Supply, is effected via at least one terminal 43. The connection to ground or CAN_GND is realized via a terminal 44. The first and second bus wire 41, 42 are terminated with a termination resistor 49.

In the transmitting/receiving device 12, the first and second bus wires 41, 42 are connected not only to the transmitting module 121, which is also referred to as a transmitter, but also to the receiving module 122, which is also referred to as a receiver, although the connections are not shown in FIG. 4 for the sake of simplicity.

During operation of the bus system 1, the transmitting module 121 of FIG. 4 can serially convert a transmit signal TxD of the communication control device 11 into corresponding signals CAN_H, CAN_L for CAN or CAN FD for the bus wires 41, 42 and transmit these signals at the terminals for CAN_H and CAN_L to the bus 40. The transmit signal TxD of FIG. 4 can be designed as a transmit signal TxD1 according to FIG. 5 or a transmit signal TxD2 according to FIG. 9. The communication control device 11 transmits the transmit signal TxD (transmit signal TxD1 according to FIG. 5 or transmit signal TxD2 according to FIG. 9) over time t (serially) via terminals TXD to the transmitting module 121, as shown in FIG. 4. As shown by way of example in FIGS. 5 and 9 for the transmit signals TxD1, TxD2, the transmit signal TxD of FIG. 4 has the voltage states H (high) and L (low) with a corresponding voltage U.

The communication control device 11 transmits the transmit signal TxD1 from FIG. 5 if communication is to take place in the bus system 1 according to CAN XL, or the transmit signal TxD2 from FIG. 9 if communication is to take place in the bus system 1 according to CAN FD or CAN FD light, over time t (serially) via the terminal TXD to the transmitting module 121, as shown in FIG. 4. As shown by way of example in FIG. 5, the transmit signal TxD1 has the voltage states H (high) and L (low) with a corresponding voltage U. On the right side of FIG. 5, the signal TxD1 is pulse-width modulated with a first symbol PWM1 and a second symbol PWM2 in the transmit signal TxD1. Here, the second symbol PWM2 differs from the first symbol PWM1, as shown, for example, in FIG. 5.

According to the example of FIG. 6, the subscriber station 100 can be designed for communication according to CAN XL to generate, for a frame 450 of FIG. 2, in the arbitration phase 451, signals CAN_H and CAN_L, which have the dominant and recessive bus levels 401, 402 according to a first physical layer 451_P, as from CAN XL. In addition, the subscriber station 100 can be designed for communication according to CAN XL to generate, for the frame 450 of FIG. 2, in the data phase 452, the bus levels L0, L1 according to a second physical layer 452_P, as from CAN XL.

FIG. 6 shows, on the left side, that the subscriber station 100, in CAN XL, in the first communication phase 451, can in each case transmit signals CAN_H, CAN_L that have a first bit time t_bt1 over time t to the bus 40. The signals CAN_H, CAN_L are serial signals and have alternatingly at least one dominant state 401 or at least one recessive state 402. If a supply voltage VCC = 5 V is used, then VCAN_H = 3.5 V and VCAN_L = 1.5 V apply for the dominant state 401, and VCAN_H = VCAN_L = 2.5 applies for the recessive state 402. A dominant state 401 (dom) is driven in the phase 451 during NRZ encoding of the transmit signal TXD if TXD = 0 or LOW (FIG. 5). A recessive state 402 (rec) is generated by the at least one termination resistor 49 between the bus lines 41, 42 for CAN_H, CAN_L, or is established in NRZ encoding of the transmit signal TXD in the phase 451 if TXD = 1 or HI (HIGH) applies (FIG. 5).

As shown on the right side of FIG. 6, the state L0 (VCAN_H = 3.0 V, VCAN_L = 2.0 V at VCC = 5 V) is driven in pulse-width modulation (PWM encoding) of the transmit signal TxD1 for the first PWM symbol PWM1 in the transmit signal TxD1. The state L1 (VCAN_H = 2.0 V and VCAN_L = 3.0 V at VCC = 5 V) is driven in pulse-width modulation (PWM encoding) of the transmit signal TxD1 for the second PWM symbol PWM2. The states L0, L1 have the bit time t_bt2, which is shorter than the bit time t_bt1.

FIG. 7 shows a differential signal VDIFF = CAN_H – CAN_L, which forms on the bus 40 as a result of the signals of FIG. 6. The individual bits of the signal VDIFF with the bit time t_bt1can be recognized by the transmitting/receiving devices 12, 22 in the arbitration phase 451 with a reception threshold T1 of, for example, 0.7 V, which lies in a range of TH_T1, as from CAN XL. With an optional reception threshold T2 of, for example, -0.3 V, which can be switched on only in the arbitration phase 451, for example, and lies in a range of TH_T2, the transmitting/receiving devices 12, 22 recognize whether or not bus levels L0, L1 are transmitted on the bus 40. With the optional reception threshold T2, a subscriber station 100 that is switched into the operating mode of the arbitration phase 451 recognizes whether bus levels L0, L1 of the data phase 452 occur on the bus 40. In the communication phase (data phase) 452, the transmitting/receiving devices 12, 22 recognize the individual bits of the signal VDIFF with a reception threshold T3 of, for example, 0.0 V, which lies in a range of TH_T3, as from CAN XL.

The sequence of the states H, L of the transmit signal TxD1 of FIG. 5 and the resulting states 401, 402 for the signals CAN_H, CAN_L in FIG. 6 along with the resulting profile of the voltage VDIFF of FIG. 7 are used only to illustrate the function of the subscriber station 100 in CAN XL. The sequence of the data states for the bus states 401, 402 can be selected as required.

The receiving module 122 forms a receive signal RxD1 from the signals CAN_H and CAN_L received from the bus 40, which are shown in FIG. 6, or the differential voltage VDIFF of FIG. 7. For generating the digital receive signal RxD1 of FIG. 8, the receiving module 122 uses the reception thresholds T1, T2, T3, as described above. In FIG. 8, the receive signal RxD1 is shown without propagation delay. The receiving module 122 forwards this receive signal RxD1 as signal RxD to the associated communication control device 11, as shown in FIG. 4.

The reception thresholds T1 and T2 are used for recognizing whether the bus 40 is free, if the subscriber station 100 is newly connected to the communication on the bus 40 and attempts to integrate itself into the communication on the bus 40.

If the subscriber station 100 communicates according to CAN CC or CAN FD or CAN FD light, the signals of FIGS. 9 to 12 are generated.

The transmit signal TxD2 of FIG. 9 is, in contrast to the transmit signal TxD1 of FIG. 5 described above, not pulse-width modulated. If the transmit signal TxD2 (FIG. 9) is driven by the subscriber station 100 of FIG. 4 onto the bus 40, the signals of FIG. 10 form on the bus 40.

According to the example of FIG. 10, the signals CAN_H and CAN_L have, in the arbitration phase 451, the dominant and recessive bus levels 401, 402, as from CAN. A difference signal VDIFF = CAN_H – CAN_L, which is shown in FIG. 10 for the arbitration phase 451, is formed on the bus 40. The individual bits of the signal VDIFF with the bit time t_bt1 can be recognized in the arbitration phase 451 and the data phase 452 with a reception threshold T_a of, for example, 0.7 V, which can be equal to the reception threshold T1 of FIG. 7.

In the data phase 452 of a CAN FD frame 460 (FIG. 3), the bits of the signals CAN_H and CAN_L can be transmitted faster, that is to say with a shorter bit time t_bt2, than in the arbitration phase 451, as described above.

Thus, the signals CAN_H and CAN_L in CAN FD and CAN FD light for the frame 460 (FIG. 3) differ, in the data phase 452, at least by their faster bit rate, from the conventional signals CAN_H and CAN_L.

The sequence of the states H, L of the transmit signal TxD of FIG. 9 and the resulting states 401, 402 for the signals CAN_H, CAN_L in FIG. 10 along with the resulting profile of the voltage VDIFF of FIG. 11 are used only to illustrate the function of the subscriber station 100. The sequence of the data states for the bus states 401, 402 can be selected as required.

The receiving module 122 of FIG. 4 forms a receive signal RxD2 from the signals CAN_H and CAN_L received from the bus 40, which are shown in FIG. 10, or the differential voltage VDIFF of FIG. 11, as shown in FIG. 12. For the generation of the digital receive signal RxD2 of FIG. 12, the receiving module 122 samples the signal VDIFF received from the bus 40 or at least one of the signals CAN_H, CAN_L at sampling points AP according to FIGS. 10 or 11, as is conventional. In FIG. 12, the receive signal RxD2 is shown without propagation delay. The receiving module 122 forwards this receive signal RxD2 as signal RxD to the associated communication control device 11, as shown in FIG. 4.

During operation of the subscriber station 100, the EAFF module 15 proceeds as follows in order, depending on the value of the configuration bit 1521, to perform or not perform a check with the EAFF frame validity check block 155. The EAFF frame validity check function of the check block 155 is switchable as needed, as described below.

The evaluation block 151 is designed to evaluate the EAFF configuration bit 1521 in the configuration block 152. The EAFF configuration bit 1521 is set if the subscriber station 100, more precisely the communication control device 11, is to be switched into an operating mode in which use of all frame formats of CAN and/or implementation variants of CAN on the bus 40 is to be accepted. The frame formats are in particular the aforementioned frame formats CAN CC, CAN FD, CAN XL, so that communication can be performed in the bus system 1 according to one of the following standards, namely in particular CAN CC, CAN FD, CAN FD light, CAN XL.

In addition to evaluation by the evaluation block 151 of whether the EAFF configuration bit 1521 is set or not set, the evaluation block 151 checks whether or not the error signaling is also disabled. For this purpose, the evaluation block 151 can check whether or not the error signaling module 115 is disabled. The error signaling module 115 can perform an error signaling according to ISO 11989-1:2024 based on a detected error 47A (FIG. 1) on the bus 40. Thus, the error signaling module 115 is designed to transmit error frames 47 or overload frames 48 to the bus 40 if the error signaling module 115 is switched on and an error 47A occurs according to the specification in ISO 11898-1:2024.

However, the EAFF module 15 itself has no influence on the error signaling. It only lifts the prohibition of other frame formats that is specified in ISO 11898-1:2024.

If the EAFF configuration bit 1521 is not set, in the present exemplary embodiment, the EAFF operating mode implemented by the EAFF module 15 is switched off. Therefore, the subscriber station 100 operates in such a way as specified in ISO 11898-1:2024. There, it is specified, among other things, that a subscriber station 100, 10X, 10Y whose error signaling is switched off can transmit and receive only frames in the CAN XL format. If such a subscriber station 100, 10X, 10Y receives a frame in another format, the frame validity check block 155 treats the received frame as an invalid frame.

If the EAFF configuration bit 1521 is set and the error signaling function of the error signaling module 115 is disabled, the subscriber station 100 operates in the EAFF operating mode as follows. It is noted here that if TMS were switched off and the CAN error signaling were therefore switched on, then the EAFF operating mode would not be needed, since the subscriber station 100 can then already transmit and receive all CAN frame formats.

The function of the EAFF module 15 is needed if high-speed FDL, in which the entire CAN FD frame 460 is transmitted at a high bit rate and the acknowledgment function in ACK is switched off, is to be operated on a CAN bus with CAN XL frames and an enabled TMS bit. Other CAN XL subscriber stations that have no EAFF function and no high-speed FDL option do not understand the frames 460 (FDL frames), and the FDL responders do not understand the CAN XL frames 450 (with or without TMS). However, the subscriber stations 10X, 10Y, 101 … 10N do not interfere with one another, because they cannot transmit error frames 47.

The EAFF module 15 is thus designed to switch the validity check that the frame validity check block 155 has to perform for a frame 450, 460 from a first validity check 1551, which is performed when the error signaling is switched on, into a second validity check 1552 if the error signaling is switched off. The switching can be performed by the switching block 153.

In the EAFF operating mode, the subscriber station 100 deviates, in the following points, from the functions specified in ISO 11898-1:2024. Accordingly, in the EAFF operating mode:
1. The subscriber station 100 can transmit frames in all other formats except error frames 47 and overload frames 48, in particular frames 450, 460.
2. The subscriber station 100 cannot transmit error frames 47 and overload frames 48.
3. The subscriber station 100 can receive syntactically correct frames in the CAN CC format and in the CAN FD format as valid frames.
4. The frame validity check block 155 performs validity checks (frame validation) for transmitted and received frames 450, 460, with the error signaling switched off, in a manner deviating from the specification of ISO 11898-1:2024, as described under the following sections 4a) and 4b). That is, the frame validity check block 155 performs, with the error signaling switched off, instead of first validity checks 1551 (frame validation) for transmitted and received frames 450, 460 specified in ISO 11898-1:2024, second validity checks 1552 (frame validation) for transmitted and received frames 450, 460. These second validity checks (frame validation) are described below.
4a) Second validity check 1552 of the frame validity check block 155 for received frames 450, 460 in the EAFF operating mode
The subscriber station 100, in particular, accepts, in the EAFF operating mode, a received frame 450, 460 or another received frame as valid if the frame has not seen an error 47A (FIG. 1) up to the last bit before the ACK slot and therefore transmits a dominant bit in the ACK slot. The errors (47A) that potentially occur in the received frame from (including) the ACK slot onward do lead to re-integration, as specified for the switched-off error signaling, but no longer render the received frame invalid.
4b) Second validity check 1552 of the frame validity check block 155 for transmitted frames 450, 460 in the EAFF operating mode
The subscriber station 100 accepts, in the EAFF operating mode, a transmitted frame 450, 460 or another transmitted frame as successfully transmitted if the subscriber station 100 samples a dominant bit in the ACK slot. The errors 47A (FIG. 1) that potentially occur thereafter in the transmitted frame do lead to re-integration, as specified for the switched-off error signaling, but the transmitted frame is nevertheless treated as successfully transmitted.

After the last bit of the end field (EOF) of the transmitted frame, in particular of a frame 450 or 460, the EAFF module 15, and thus the EAFF operating mode described above, remains permanently active. The reason for this is that the validity checks of the EAFF module deviate from the standard ISO 11898-1:2024 only for CAN CC frames and for CAN FD frames 460, but are usable for CAN XL frames with the error signaling switched off.

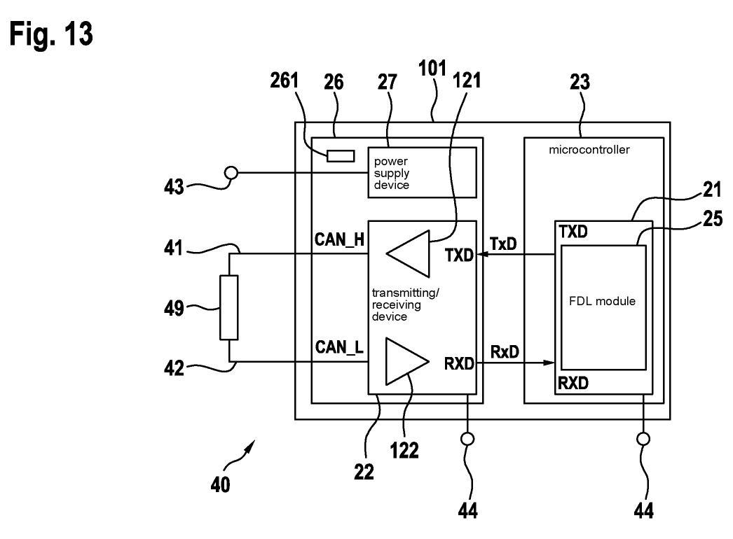

According to FIG. 13, the responder subscriber station 101 has, in addition to the communication control device 21 and the transmitting/receiving device 22, a simple control unit (FSM) or optionally a microcontroller 23, to which the communication control device 21 is assigned, and a system ASIC 26 (ASIC = application-specific integrated circuit), which can alternatively be a system basis chip (SBC) on which a plurality of functions necessary for an electronics assembly of the subscriber station 101 are combined. The system ASIC 26 in particular has an application 261, which can be designed as a computer program (app). Such an application is a technical application 261. The application 261 is, for example, a controller for a sensor or a transducer or an actuator or the like, which is controlled by the application 161 (FIG. 4) of the subscriber station 100 in its function as commander or is to provide data for the application 161.

In the system ASIC 26, a power supply device 27 which supplies the transmitting/receiving device 22 with electrical energy is installed in addition to the transmitting/receiving device 22. The power supply device 27 usually supplies a voltage CAN_Supply of 5 V. Depending on requirements, however, the power supply device 27 can provide a different voltage with a different value. Additionally or alternatively, the power supply device 27 can be designed as a current source.

The communication control device 21 generates, using the FDL module 25, a frame 460 in which no bit rate switching or no bit rate change is carried out, and/or evaluates such a frame 460 based on the frame 460 received from the commander subscriber station 100. The communication control device 21 can also be designated as an FDL responder. The devices 21, 22 can only transmit such a frame 460 to the bus 40 upon request from the commander subscriber station 100 (polling).

The transmitting/receiving devices 12 need not be designed as a SIC XL transmitting/receiving device. That is, the transmitting/receiving device 12 can be designed like a conventional CAN FD transmitting/receiving device 12. However, the CAN FD light commander, for example the subscriber station 100, must be operated, for CAN FD light communication on the bus 40, in the EAFF operating mode, as described above. The other CAN XL subscriber stations 10X, 10Y do not necessarily need the EAFF module 15 and its function. Without the EAFF module 15 and its function, a CAN XL subscriber station 10X, 10Y cannot understand the FDL frames 460. However, a CAN XL subscriber station 10X, 10Y can obtain the data from the FDL frame 460 by way of the subscriber station 100, wherein the EAFF module is enabled; i.e., the use of all frame formats except error frames 47 and overload frames 48 is permissible on the bus 40. Without error frames 47, CAN XL subscriber stations 10X, 10Y do not destroy the FDL frames 460.

As described above, in CAN FD light, because of the absence of arbitration, bit rates > 1 Mbit/s are also permitted, in particular up to 8 Mbit/s. As a result, as a major difference relative to communication according to CAN FD in the bus system 1, the transmission speed between the responder subscriber station 101 and the commander can be significantly faster than in CAN FD communication.

The frames 460 of the CAN FD light commander, which here is the subscriber station 100, and the frames 460 of the responders 101 can be received and understood by all subscriber stations 100, 10X, 10Y, 101 … 10N connected to the bus 40, wherein the subscriber stations 100, 10X, 10Y have, for this purpose, the function of the EAFF module 15.

The transmitting module 222 of FIG. 13 is otherwise structured, in relation to the transmit function for transmitting CAN FD frames 460 to the bus 40, in the same way as described above for the transmitting module 122 of FIG. 4.

If the CAN FD light frames, in particular frames 460, are transmitted at higher bit rates, e.g., > 1 Mbit/s, the bit rate in the first communication phase 451 of CAN XL frames 450 nevertheless must be transmitted at a lower bit rate, as specified in ISO 11898-1:2024. CAN FD light commanders can provide their own configuration for the bit rate of CAN FD light frames with a higher bit rate, or they can, e.g., use the bit rate configuration provided for the second communication phase 452 of CAN FD frames 460 for the entire CAN FD light frame.

According to a second exemplary embodiment, the EAFF module 15 is designed, in the EAFF operating mode, to perform the validity check at a later bit position for received and for transmitted frames 450, 460, or other CAN frames, than described in the first exemplary embodiment. For example, the validity check is therefore performed in the ACK slot upon reception or in the EOF field.

This later validity check would not improve the function of the bus system 1. The reason for this is that error handling for bits after the ACK slot was provided so that a reaction to error flags or error frames 47 of other subscriber stations 100, 10X, 10Y, 101 … 10N occurs there in order to maintain system-wide data consistency (fault confinement).

Given that, in the EAFF operating mode, the error signaling is switched off, there are no error flags to which the subscriber station 100 could react.

According to a third exemplary embodiment, the EAFF module 15 is designed, in the EAFF operating mode, to perform the validity check for received frames 450, 460 or other CAN frames at an earlier bit position than described in the first exemplary embodiment, but at the earliest upon reception of the last bit of the checksum CRC.

In CAN CC and CAN FD frames, the validity check can, for example, be carried out upon reception of the CRC bit0.

In CAN XL frames, the validity check can, for example, be carried out upon reception of the bit FCP0 or one of the bits DAH, AH1, AL1.

According to a fourth exemplary embodiment, the EAFF module 15 is designed, in the EAFF operating mode, to perform the validity check for transmitted frames at an earlier bit position than described in the first exemplary embodiment. However, the acknowledge bit transmitted by the receiving nodes could then not be considered. This would have disadvantages in some application cases.

According to a fifth exemplary embodiment, the EAFF module 15 is designed to implement the configuration option EAFF as follows.

Here, the configuration option EAFF operating mode is implemented in such a way that a set configuration bit 1521, or EAFF = ON, means that the CAN error signaling of the implementation is switched off.

All above-described embodiments of the subscriber stations 100, 101 … 10N, 10X, 10Y of the bus system 1 and the method carried out therein can be used individually or in all possible combinations. In particular, all features of the above- described exemplary embodiments and/or their modifications can be combined as desired. Additionally or alternatively, the following modifications are possible in particular.

Even if the present disclosure is described above using the example of the CAN bus system, the present disclosure can be used in any communication network and/or communication method in which two different communication phases are used in which the bus states generated for the different communication phases can be different.

In particular, the bus system 1 according to the exemplary embodiments can be a communication network in which data can be transmitted serially at two different bit rates. It is advantageous, but not necessarily a prerequisite, for an exclusive, collision-free access of a subscriber station 100, 101 … 10N to a common channel to be ensured for the bus system 1, at least for certain time periods.

In the exemplary embodiments, the number and arrangement of the subscriber stations 100, 101 … 10N, 10X, 10Y in the bus system 1 is arbitrary. In particular, it is possible for one or more of the subscriber stations 100 to be present in the bus system 1. In particular, it is possible that there is in the bus system 1 more than one subscriber station 100 to which at least one subscriber station 101 ... 10N is assigned, as described above. In order not to disturb arbitration between the subscriber stations 100, 10X, 10Y on the bus 40, messages 46 from subscriber stations 101 … 10N (responders) therefore have an identifier (ID) having higher priority than the identifier(s) (ID) of the subscriber station 100, 10X, 10Y or another CAN FD subscriber station.

In particular, only one subscriber station 100 (commander) and at least one subscriber station 101 …10N (responder) are present, as shown in FIG. 1.

It is possible that, in the subscriber stations 100, the EAFF module 15 and/or the FDL module 110 is arranged separately from the communication control device 11. It is possible that, in at least one of the subscriber stations 100, 101 ... 10N, the FDL module 25 is arranged separately from the communication control device 21.

What is claimed is:

1. A subscriber station for a serial bus system, comprising:
a communication control device configured to control serial communication of the subscriber station with another subscriber station of the bus system and to evaluate at least one signal received from a bus of the bus system based on a frame, in which a bit time in a first communication phase can differ from a bit time in a second communication phase; and
an enable all frame formats (EAFF) module configured to perform a validity check for a frame transmitted to the bus by the subscriber station or received from the bus;
wherein the validity check is configured to accept more than one format for frames on the bus as valid if an error signaling, with which the subscriber station can signal an error in the frame checked for validity on the bus, is switched off.

2. The subscriber station according to claim 1, wherein:
the EAFF module is configured to perform, instead of a first validity check to be performed when the error signaling is switched on, a second validity check when the error signaling is switched off;
the second validity check differs from the first validity check that is to be performed, when the error signaling is switched on, for the frame transmitted to the bus by the subscriber station or received from the bus.

3. The subscriber station according to claim 2, wherein:
the EAFF module is configured to, during the second validity check, accept the received frame as valid if the EAFF module has not seen an error during a check of the received frame up to a last bit before an acknowledgment field;
other subscriber stations connected to the bus can acknowledge correct reception of the frame in the acknowledgment field.

4. The subscriber station according to claim 2, wherein:
the EAFF module is configured to, during the second validity check, accept the received frame as valid if the EAFF module has not seen an error during a check of the received frame up to a bit in a field before an acknowledgment field;
other subscriber stations connected to the bus can acknowledge correct reception of the frame in the acknowledgment field.

5. The subscriber station according to claim 2, wherein:
the EAFF module is configured to, during the second validity check, accept the transmitted frame as successfully transmitted if the EAFF module, during a check of the transmitted frame in an acknowledgment field in which other subscriber stations connected to the bus can acknowledge correct reception of the frame, samples a dominant bit.

6. The subscriber station according to claim 2, wherein:
the EAFF module is configured to, during the second validity check, accept the transmitted frame as successfully transmitted if the EAFF module has not seen an error during a check of the transmitted frame up to a bit in a field before an acknowledgment field; and
other subscriber stations connected to the bus can acknowledge correct reception of the transmitted frame in the acknowledgment field.

7. The subscriber station according to claim 2, wherein:
the EAFF module is configured to, during the second validity check, accept the received frame as valid or to accept the transmitted frame as successfully transmitted if the EAFF module has not seen an error during a check of the received or transmitted frame up to a last bit before an acknowledgment field;
other subscriber stations connected to the bus can acknowledge correct reception of the received or transmitted frame in the acknowledgment field.

8. The subscriber station according to claim 2, wherein the EAFF module includes a configuration block in which a value for at least one validation check configuration bit is stored, which indicates whether or not, when the error signaling is switched off, frames other than CAN XL frames may also be transmitted on the bus.

9. The subscriber station according to claim 8, wherein the EAFF module further includes:
an evaluation block configured to evaluate the value of the at least one configuration bit;
a frame validity check block configured to perform at least the second validity check; and
a switching block configured to switch on or switch off the second validity check of the frame validity check block based on the evaluation of the evaluation block.

10. The subscriber station according to claim 1, wherein:
the subscriber station is a commander subscriber station that is configured to transmit predetermined frames, in a transmission request, via the bus to a responder subscriber station, so that the responder subscriber station transmits a predetermined frame to the commander subscriber station only after the commander subscriber station has requested the responder subscriber station to transmit the predetermined frame;
the predetermined frame is a CAN FD frame in a FBFF format.

11. A bus system, comprising:
a bus; and
at least two subscriber stations, which are connected to one another via the bus in such a way that the at least two subscriber stations can communicate with one another serially, wherein one of the at least two subscriber stations is a subscriber station including:
a communication control device configured to control serial communication of the subscriber station with another subscriber station of the bus system and to evaluate at least one signal received from a bus of the bus system based on a frame, in which a bit time in a first communication phase can differ from a bit time in a second communication phase, and
an enable all frame formats (EAFF) module configured to perform a validity check for a frame transmitted to the bus by the subscriber station or received from the bus,
wherein the validity check is configured to accept more than one format for frames on the bus as valid if an error signaling, with which the subscriber station can signal an error in the frame checked for validity on the bus, is switched off, and
at least one subscriber station of the at least two subscriber stations is a responder subscriber station;
wherein each of the at least two subscriber stations also includes a transmitting/receiving device configured to transmit a transmit signal to the bus of the bus system and/or to receive a signal from the bus of the bus system.

12. The bus system according to claim 11, further comprising:
at least one third subscriber station which is configured to transmit and/or receive signals based on a frame;
wherein the at least one third subscriber station includes a communication control device, which is configured to negotiate with the commander subscriber station, in a first communication phase of a frame, whether the third subscriber station or the commander subscriber station will receive at least temporarily exclusive, collision-free access to the bus in a subsequent second communication phase.

13. A method for communication in a serial bus system, wherein the method is carried out using a subscriber station which has a communication control device configured to control serial communication of the subscriber station with another subscriber station of the bus system, and to evaluate at least one signal received from a bus of the bus system based on a frame, in which a bit time in a first communication phase can differ from a bit time in a second communication phase, the method comprising the following steps:
performing, with an enable all frame formats (EAFF) module, a validity check for a frame transmitted to the bus by the subscriber station or received from the bus;
wherein, during the validity check, more than one format for frames on the bus is accepted as valid when an error signaling with which the subscriber station can signal an error in the frame checked for validity on the bus is switched off.
